(19) United States
(12) Patent Application Publication
(10) Pub. No.: US 2026/0261429 A1
(43) Pub. Date: Sep. 3, 2026

(54) SYSTEMS AND METHODS FOR CERTIFYING RESOURCES IN A MULTI-OWNED COMPUTING ENVIRONMENT

(71) Applicant: Robert Bosch GmbH, Stuttgart (DE)

(72) Inventors: Sebastian BECKER, Ludwigsburg (DE); Sven TRIEFLINGER, Renningen (DE); Pradeep M. PAPPACHAN, Pittsburgh, PA (US); Shalabh JAIN, Pittsburgh, PA (US); Stefan GEHRER, Pittsburgh, PA (US)

(21) Appl. No.: 19/067,149

(22) Filed: Feb. 28, 2025

(51) Int. Cl. H04L 9/32; H04L 9/00; H04L 9/08

(52) U.S. Cl. CPC H04L 9/3247; H04L 9/0869; H04L 9/3268; H04L 9/50

(57) ABSTRACT

A method for generating a certified resource for a multi-owned computing environment (MOCE) includes, using one or more computing devices, establishing a confidential computing system using a trusted execution environment (TEE), the confidential computing system including the MOCE, generating, within the MOCE, a resource configured to be used by one or more participating parties (PPs) associated with the MOCE, collecting verification information associated with the resource, the verification information including information indicating at least a configuration of the MOCE, using a signing service to establish the resource as the certified resource by applying a digital signature to the verification information and bundling the resource with the verification information, and storing the certified resource within the MOCE for use by the one or more PPs.

### TECHNICAL FIELD

The present disclosure relates to multi-party or multi-owned computing environments.

### BACKGROUND

Various collaborative processes (e.g., digital cleanrooms, collaborative learning for AI, etc.) involve multiple entities/parties. In one example, distributed software integrations and build processes may involve multiple entities/parties independently developing and testing respective portions (e.g., software modules) of a software application and then integrating the various software modules to build the application within a computing environment (e.g., as implemented in a cloud computing system). For example, in the automotive industry, original equipment manufacturers (OEMs) and suppliers may collaborate to develop software applications that are executed on embedded systems inside vehicles. This model of collaboration may include each entity separately developing and testing some portion of the software application to defined specifications (e.g., respective requirements, application program interface (API) specifications, etc.) and eventually integrating the various software portions before final testing and implementation. In some examples, a computing environment is configured to be set up and operated by a single party or entity with full administrative power.

### SUMMARY

A method for generating a certified resource for a multi-owned computing environment (MOCE) includes, using one or more computing devices, establishing a confidential computing system using a trusted execution environment (TEE), the confidential computing system including the MOCE, generating, within the MOCE, a resource configured to be used by one or more participating parties (PPs) associated with the MOCE, collecting verification information associated with the resource, the verification information including information indicating at least a configuration of the MOCE, using a signing service to establish the resource as the certified resource by applying a digital signature to the verification information and bundling the resource with the verification information, and storing the certified resource within the MOCE for use by the one or more PPs.

Other embodiments include systems, one or more processors or processing devices, or other circuitry configured to implement functions corresponding to the principles of the present disclosure.

### BRIEF DESCRIPTION OF THE DRAWINGS

FIG. 1 illustrates an example cooperative computing environment.

FIG. 2 illustrates an example cooperative computing environment including a management gateway.

FIG. 3 illustrates an example confidential computing system configured to perform resource certification according to the systems and methods of the present disclosure.

FIG. 4 is a block diagram of an example computing device configured to implement functions of the systems and methods of the present disclosure.

FIG. 5 illustrates steps of an example method for performing resource certification in a confidential computing environment according to the principles of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In some examples, a computing environment is configured to be set up and operated by a single party or entity with full administrative power. If such an environment is used in collaborative or cooperative settings in which multiple entities contribute potentially sensitive or valuable digital assets (e.g., data, algorithms) to the overall system, the power of that single party to change the environment at any time in any way is problematic. For example, collaborating entities may not trust each other with respective intellectual property (IP), an entity with administrative power may now know assets (e.g., intellectual property) of other entities, etc. One established method for resolving this issue is to delegate the setup and operation of the computing environment (CE) to a trusted (third) party (TP). Trust extended to the TP is based on an assumption that the TP does not have interest in the digital assets that would create an incentive to extract or modify the digital assets, or the TP may be bound by various contracts or agreements not to disclose assets or other information. Further, capability of the TP to operate the environment in a secure way to prevent internal and external security threats is assumed.

FIG. 1 illustrates an example cooperative computing environment (CE) 100. For example, the CE 100 includes a computing system 104 (e.g., a computing environment implemented in a cloud computing system, one or more servers or distributed computing devices, a computing cluster, etc.) accessible by multiple entities that are users or providers of digital assets within the CE 100, which, in some examples, may correspond to developer entities 108. The entities 108 may independently develop and test respective portions (e.g., workloads 112) of a software application within the computing system 104.

If one or more of the entities 108 contribute potentially sensitive or valuable digital assets to the computing system 104, it may not be desirable for any one of the entities 108 to control the CE 100. Accordingly, in some examples, the CE 100 is configured to be set up and operated by a single party or entity with full administrative access. For example a trusted third party (TP) 116 may be assigned full administrative privilege, which may include access to a policy engine 120 configured to control setup of the computing system 104, changes to the computing system 104 subsequent to setup, etc. In some examples, the trusted TP 116 may be one of the entities 108. However, trust extended to the TP 116 is based on an assumption that the TP 116 does not have interest in the digital assets that would create an incentive to extract or modify the digital assets. Further, capability of the TP 116 to operate the CE 100 in a secure way to prevent internal and external security threats must be assumed by the entities 108.

In some examples, advanced privacy-preserving computing techniques are used to establish a confidential CE (CCE) that provides a consensus-based setup and management mechanism for the CE that performs a management operation only if all contributing entities agree. These systems replace the trust-based operations model for multi-party CEs with a model that technically enforces the rules of cooperation within the CE and allows auditing of the enforcement process. Example systems and methods for establishing a confidential CE in this manner are described in more detail in U.S. patent application Ser. No. 18/594,777, filed 4 Mar. 2024, the entire contents of which are incorporated herein by reference.

For example, a mechanism is provided for setting up and operating a multi-owned computing environment (MOCE) (e.g., a CE that is set up and operated under the governance of more than one party/entity). The MOCE includes an interface for admitting the execution of management operations of a cluster (e.g., one or more build servers, computing devices, etc. used by multiple parties to implement a software build) only if a consensus among the owners of the environment is reached that an operation is permitted. Integrated policy engines implement versatile and flexible operation management (e.g., to define which operations can be performed and by which entities, in which circumstances, etc.). A sandboxing mechanism for workloads of the respective entities is executed within the MOCE and allows for tight control over what a workload is permitted to do (e.g., accessing other digital assets, opening network connections, etc.), and which resources the workload is permitted to consume (e.g., main memory, CPU/GPU time, etc.). The MOCE may further include a tamper-proof auditing mechanism to track which management operations have been performed by which entities (and when the management operations were performed) and a backup and recovery mechanism.

As used herein and described below in more detail, “CMI” refers to a consensus-driven management interface. “Participating party” (PP) refers to a party participating in a collaboration enabled by the principles of the present disclosure on the CE. The terms “party” and “entity” may be used interchangeably. A “computing environment” (CE) refers to the environment used by the PPs for collaboration, such as on a software build. Although described with respect to a collaboration for a software build, in other examples the principles of the present disclosure may be implemented for other types of collaborative CEs. A “hosting party (HP) refers to the party that instantiates the CE on its own or third-party infrastructure. “Trusted execution environment (TEE) refers to one example environment that is secure in accordance with confidential computing techniques that implement hardware protection techniques. A TEE provides the ability to establish trust in the TEE by a process called remote attestation (RA). A controller TEE is a TEE that hosts the control logic implementing the CMI and performs the management actions on the CE when consensus is reached. A controller TEE is implemented using one or more computing devices, processors or processing devices, etc.

Computing environments according to the present disclosure are configured to implement a consensus-driven management interface (CMI or CMMI) or consensus-driven management API (CAPI). A CMI or CAPI according to the present disclosure is an interface over which PPs can make a proposal or request for invoking a management functionality exposed over the interface. In an example embodiment, to set up the CE, the hosting party (HP) launches a TEE, referred to herein as the controller TEE (CTEE, or “controller in a trusted execution environment”), on a computing device or platform configured to provide the required confidential computing support. The computing device can be a public cloud provider, an on-premises datacenter (e.g., local to one or more of the entities), or combinations thereof. The CMI is implemented via a CTEE, which may be referred to as a management gateway.

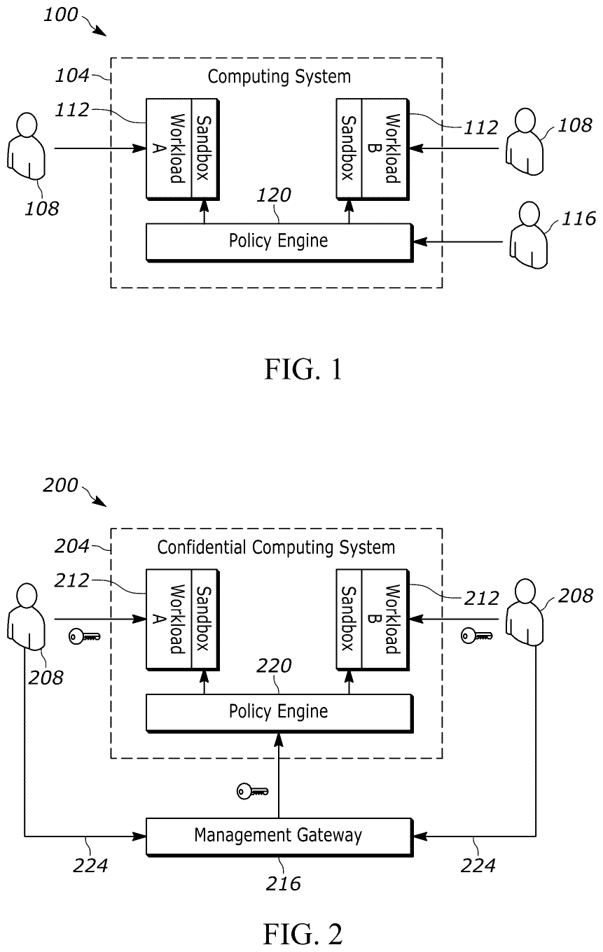

FIG. 2 illustrates an example cooperative computing environment (CE) 200 configured to implement a CMI. For example, the CE 200 includes a confidential computing system 204 (e.g., a computing environment implemented in a cloud computing system, one or more servers or distributed computing devices, a computing cluster, etc.) accessible by multiple developer entities (e.g., PPs, client computing devices, etc.) 208. The entities 208 may independently develop and test respective portions (e.g., workloads 212) of a software application within the computing system 204. In an example, the computing system 204 implements or is implemented by a confidential Kubernetes (K8s) cluster.

The CE 200 is configured to remove the need for a trusted TP by using advanced privacy-preserving computing techniques to establish an interface to the CE 200 that provides a consensus-based setup and management mechanism for the CE 200 that performs a management operation only if all contributing entities agree.

For example, the CE 200 is configured to implement a trusted, consensus-based management gateway 216. In an example, the management gateway 216 is configured to implement and/or operate in accordance with a TEE. The management gateway 216 is used to set up and operate the CE 200 (e.g., via management and control of policy engine 220). The computing system 204 is further configured to implement other components of the systems and methods described above, such as the operating system, controller software module, etc.

The management gateway 216 is configured to function as an interface for admitting the execution of management operations in the computing system 204 only if a consensus among the entities 208 is reached that an operation is permitted. In some examples, “consensus” may require agreement from all entities. In other examples, consensus may be achieved by agreement from a subset of all entities (e.g., a number of entities less than a total number of the entities), by reaching a threshold value (e.g., a threshold value corresponding to a combination of weighted votes or values from respective entities), etc. For example, the management gateway 216 (in communication with and responsive to the controller software module implemented on/by the computing system 204) is configured to implement all or portions of the CMI or CAPI described herein. Although shown separate from the computing system 204 (e.g., “off-cluster”), in other examples the management gateway 216 may be integrated with (e.g., located within) the computing system 204.

Accordingly, the management gateway 216 is configured to provide an interface over which the entities 208 can make a proposal or request for invoking a management functionality (e.g., via respective control paths 224). For example, any proposals or requests are provided from the entities 208 to the management gateway 216 and kept in a pending state until all (or a defined subset) of the entities 208 have approved the proposal in accordance with the systems and methods described herein.

In confidential computing systems such as the CE 200, management and access to potentially highly sensitive data stored in the CE 200 (e.g., by individual services deployed in the CE 200, users with access to the CE 200, etc.) may be strictly regulated and changes to the CE 200 may be prevented without consensus among the PPs as described above. However, a MOCE is expected to be a long-running deployment with the need for frequent updates of individual services or updates to the configuration of the MOCE and/or associated components. Example updates may correspond to security updates, new policies required for specific use cases, parties leaving or joining the MOCE, etc. Resources loaded into or generated within the MOCE may outlast one or more configurations/components of the CE 200 that require periodic updating. Accordingly, tracking/determining settings under which resources were initially added, updated, or generated may be difficult. The term “resources” as used in the present disclosure may describe both resources in the context of Kubernetes resources (e.g., containers, services, volumes, configmaps, etc.) and artifacts (e.g., executables, build artifacts, human-or machine-readable data, datasets, etc.). Generally, resources may include computational resources (e.g., processing resources, memory resources, etc.), storage resources, network resources, security resources, and so on.

Resource certification systems and methods according to the present disclosure are configured to certify resources by bundling a given resource with information about the configuration of the MOCE and other attributes (e.g., input parameters, associated PPs, etc.). As used herein, a certificated resource (CR) is a resource that includes properties identifying the configuration, attributes, etc. of the MOCE at the time the resource was loaded into or generated within the MOCE. Accordingly, CRs according to the present disclosure allows interested parties to view and verify properties.

In this manner, parties jointly managing the MOCE may update system components when a consensus is reached among PPs, deploy individual components and/or upload artifacts to the CE 200 according to the configuration and rules of the CE 200, and/or implement or execute internal services and pipelines to generate new artifacts. CRs resulting from such updates can outline/define a system configuration that was active when the resources were deployed, uploaded into, and/or generated within the MOCE.

In an example, a CE according to the present disclosure includes a resource management module (which may be referred to herein as a MOCE configuration manager, resource manager, controller, pipeline, circuitry, etc.) configured to enrich/augment/enhance resources with verifiable information about the configuration of the MOCE and other defined parameters (e.g., system time, executing party/parties, etc.) using verifiable deployment functionality of the MOCE. As an example, the information may correspond to metadata. This information can be used for documentation, revision and/or other purposes (e.g., proving origin and integrity of resources). As an example, when resources such as build artifacts or datasets are leaving the protected CE, external parties/components are able to verify various properties of the resource without being members (e.g. PPs) of the MOCE or CTEE. Further, users are able to verify whether some types of resources (e.g., Kubernetes containers) were deployed in accordance with existing policies of the CE (e.g., as a verification mechanism in addition or alternative to an auditing log). For example, resources that were generated/deployed under a previous configuration may violate a current set of policies (e.g., in cases where the configuration changed subsequent to an original generation/deployment of a resource).

As used herein, a signing service (SS) is a system component implemented by systems and methods of the present disclosure. The SS enables enrichment of resources with verifiable information (such as origin information associated with the resource, the configuration of the MOCE, etc.) as described below in more detail. The verifiable information may correspond to metadata stored within a data structure associated with the resource. As used herein, the verifiable information may be referred to as verification information or certification information.

As used herein, the term “resource” refers to resources in the context of computing cluster resources, such as Kubernetes resources (e.g., containers, services, volumes, configmaps, etc.) as well as artifacts (e.g., executables, build artifacts, human-or machine-readable data and datasets, etc.). Resources can either be uploaded to the CE, generated within the CE as a result of a dedicated process, etc.

As used herein, the term “certified resource (CR)” refers to a resource in a MOCE that has been certified along with a set of defined properties such as the configuration of the MOCE configuration, resource specific attributes, etc. in accordance with the principles of the present disclosure. In other words, CRs according to the present disclosure are enriched/enhanced with additional properties or information (e.g., verification or certification information). The term “resource” as used below may be assumed to refer to a certified resource in the context of the principles of the present disclosure.

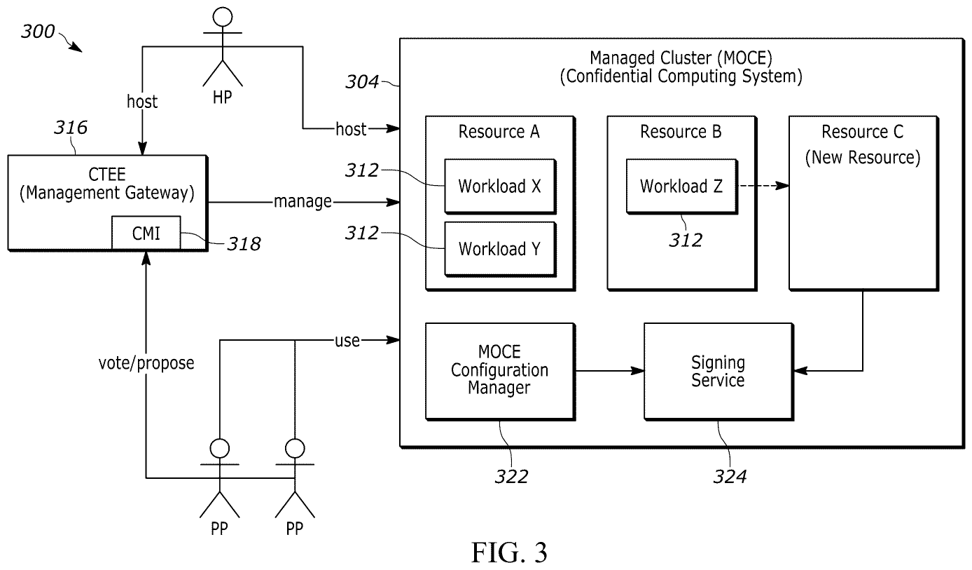

FIG. 3 illustrates an example CE 300 configured to implement resource certification techniques according to the principles of the present disclosure. The CE 300 may be generally configured in a manner similar to the CE 200 of FIG. 2. Some elements shown in FIG. 2 are omitted from FIGS. 3A and 3B for simplicity. For example, the CE 300 includes a confidential computing system/MOCE 304 accessible by multiple developer entities (e.g., PPs, client computing devices, etc.). For example, different portions (e.g., workloads 312 associated with respective resources A, B, etc.) of a software application within the computing system 304 may be independently accessed by respective entities for developing and testing. In an example, the MOCE 304 implements or is implemented by a confidential Kubernetes (K8s) cluster. Accordingly, the MOCE 304 may be referred to as an MOCE, and the terms “computing system” and “MOCE” may be used interchangeable in the context of the system 304.

The CE 300 includes a CTEE 316 configured to host/execute control logic for implementing a CMI 318. In some contexts, functionality of the CTEE 316 may be referred to as a management gateway (e.g., a trusted, consensus-based management gateway configured to implement and/or operate in accordance with a TEE).

The CE 300 according to the present disclosure is configured to implement resource certification systems and methods to enrich resources in the MOCE 304 (e.g., enrich resources with verifiable properties such as configuration information of the MOCE 304, resource-specific attributes of the MOCE 304, etc. For example, the MOCE 304 may implement all or portions of a MOCE configuration manger 322 and a signing service (SS) or SS module 324 as described below in more detail. Although the configuration manager 322 and the SS 324 are shown located within the MOCE 304, all or portions of the configuration manager 322 and the SS 324 may be implemented by the CTEE 316.

The SS 324 according to the present disclosure are configured to control generation of new certified resources (e.g., a new resource “C_{cert}”) within the CE 300. As used herein, “generating” a resource refers to various functions associated with provisioning, allocating, and provisioning a resource for use by one or more PPs in the MOCE 304. In one example resource generation process, the new resource C may be generated in response to a quorum of the PPs (e.g., all of the PPs, a simple majority of the PPs, etc.) agreeing to generate the new resource via a voting or other consensus mechanism. As an example, the Workload Z 312 is configured such the new resource C is generated based on private input from each of the PPs. The output resource C is provided to the SS 324 along with configuration information from the configuration manager 322. The SS 324 is configured to “sign” (e.g., apply a digital signature to) the resource and embed resource-specific attributes defined in the pipeline prior to persisting or returning the result to the MOCE 304. As used herein, “persisting” a resource refers to storing data and/or state information corresponding to the resource. This example process can be applied to a single resource generated by the pipeline or multiple resources such as executables, human-or machine-readable data, datasets, etc.

In one example, functions performed by the SS 324 to generate new resources may include:

Generating (which may include/correspond to allocating), using a pipeline executed by the workload 312, a resource;

Providing the resource and attributes defined in the pipeline (e.g., attributes defined at least in part by the configuration of the MOCE 304) and configuration of the MOCE from the configuration manager 322 to the SS 324;

Collecting and bundling, at the SS 324, information defined by the attributes of the resource and the current state and configuration of the MOCE 304) such as by (i) using the SS 324, retrieving additional information from other sources (e.g., sources within the CE 300 but external to the SS 324) as defined by the configuration of the SS 324 or the MOCE 304, described by the attributes defined by the pipeline and added to the resource, etc. (e.g., additional information including, but is not limited to, a list of contributing PPs, attributes of individual inputs to the pipeline, a RA report of the CE 300, system logs, etc. and (ii) processing, using the SS 324, the information collected (e.g., collected from the configuration manager 322, collected using the SS 324, etc.) to format or extract specific attribute information or derive additional attributes;

Signing, using the SS 324, the collected information (described below in more detail), such as by computing a cryptographic digest, for example a cryptographic hash, over the collected/bundled information and signing the hash with a private key that can be attributed exclusively and verifiably to the SS 324; and

Using the SS 324, returning or persisting the resource, the collected information, and the applied signature as defined by the pipeline (e.g., as a usable resource within the MOCE 304).

One example process for generating and applying the signature to (i.e., signing) the collected information (e.g., as performed by the SS 324) is described below. The collected information is signed such that inspecting parties can verify and attribute the signature exclusively to the SS 324. The signature can also be used by interested parties to verify the integrity of the SS 324 to establish trust in the information and signature attached to the resource. For example, the SS 324 may be configured to generate or be issued a public/private key pair that can be linked to a RA report proving the integrity of the SS 324. The SS 324 can use the private key to sign the collected information and provide the public key to interested parties to allow the verification of the signature. In one example, the public key may be provided to interested parties as provided to or generated/stored by the SS 324. In other examples, the public key may be embedded into a certificate that binds the public key to the identity of the SS 324. Example optional steps to either generate or issue a key pair that can be used to verify the signature and trustworthiness of the SS may include, but are not limited to:

Deploying the SS 324, either separately or as a service within the MOCE 304, by the CTEE 316 such that the CTEE 316 can verify and attest the integrity of the deployment. In examples where the SS 324 is deployed separately, the SS 324 may be deployed with protection by additional confidential computing mechanisms that allow users to verify deployment integrity (e.g., using a separate RA process for the SS 324). The SS 324 may then generate a key pair to be used for signing the collected information. As the deployment of the SS 324 is managed by the CTEE 316, interested parties can verify the integrity of the SS 324 by verifying deployment by the CTEE 316 using RA;

Managing deployment of the SS 324 using the CTEE 316 by issuing the SS 324 a key pair generated by the CTEE 316. Since the CTEE 316 is verifiable, the process to generate the key pair may be verified and the key pair can be considered trustworthy by the PPs; and

Deploying the SS 324 independently from the MOCE 304 and protecting the SS 324 using confidential computing mechanisms. Deployment of the SS 324 can be verified by each of the PPs, as well as by external parties, using RA and is therefore considered trustworthy. The SS 324 may be configured to generate a key pair used to sign the collected information.

As described in the options above, the SS 324 can either generate or is issued a key pair for signing and verifying the collected information. The public key is made available for inspection or download to interested parties via an interface (e.g., an interface of the CTEE 316, such as the CMI 318, an associated with the SS 324, etc.). Interested parties can verify the integrity of the SS 324 and the public key by attesting the deployment of the CTEE 316 or the SS 34 using RA. In an example where the CTEE 316 holds a certificate that is considered trustworthy (e.g., the certificate is signed by a trusted organization/authority), the public key of the SS 324 may be embedded into a certificate (e.g., with an RA report of deployment of the SS 324) or embedded into the CTEE 316.

In examples where the certificate of the SS 324 is considered valid, the SS 324 may be considered trustworthy without interested parties having to independently perform RA. To issue such a certificate, the public key generated may also be embedded into a certificate signing request (CSR) to be signed in accordance with the certificate of the CTEE 316 or a higher-level authority subsequent to RA.

Subsequent to signing the collected information, the SS 324 may attach, to the new, certified resource, a proof or certification of the integrity of the MOCE 304, such as the RA report for the CTEE 316, the configuration of the MOCE 304 signed with the public key, etc. In this manner, the integrity and origin of the resource can be verified, using only the public key, when the resource leaves the MOCE 304.

In some examples, resource certification systems and methods as described herein may be used to certify Kubernetes resources. For example, the SS 324 may be configured to verify Kubernetes resources such as services, pods, secrets, etc. in the MOCE 304. As one example, the SS 324 signs the configuration of the resource, which may be embedded with additional information such as an identifier of the resource, a current set of rules in the MOCE 304, a general configuration of the MOCE 304 retrieved from the CTEE 316, etc. The configuration can be attached to the resource or published on a different channel (e.g., a log).

In another embodiment, the SS 324 can be highly integrated into deployment flows of Kubernetes operation (e.g., using Lifecycle Hooks or Events of a Kubernetes cluster). Whenever a resource is created, the information from the resource as defined in the configuration can be measured or collected and attached, along with the generated signature, to the resource. The MOCE 304 may have policies enrolled that prevent modification of the attached certificate of a resource by entities other than the SS 324.

The information attached along with the signature can be used to verify the compliance of a resource with the configuration of the MOCE 304 and (e.g., previously) enrolled rules even when the configuration and rules change/evolve over time. This feature may be advantageous when resources such as Kubernetes pods are not deployed explicitly but instead are deployed by Kubernetes Operators or extensions (e.g., Knative) that automatically scale containers according to a given configuration.

In some examples, systems and methods according to the present disclosure may implement certificate-less verification of resources. For example, instead of signing the collected information and returning the result with the certificate as described above, the SS 324 may store collected verification data separately in a dedicated log (e.g., a distributed, tamper-proof log using interplanetary file systems (IPFS) or cryptographic hash chains) to further prove chronology of artifacts and logs. In examples where deployment of the SS 324 is managed by the CTEE 316 and therefore trustworthy, the distributed log is tamper-proof. In this manner, the distributed log may replace the separate signing of properties/attributes or provide additional measures for verification.

In some examples, systems and methods according to the present disclosure may implement traceability and rights-management techniques. For example, as an alternative to storing or returning the certification data along the resource as described above, the collected information can be embedded into the generated resource using watermarking technologies. In this manner, resources can be traced verifiably when leaving the MOCE 304.

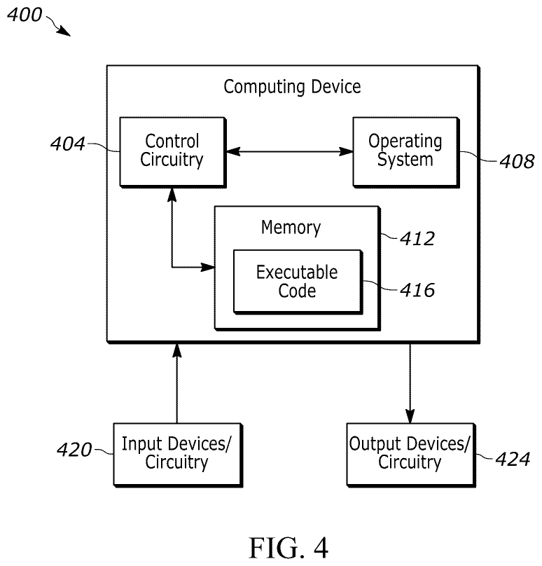

FIG. 4 shows a block diagram of an example computing device 400 configured to implement functions of the systems and methods described herein according to the present disclosure. For example, one or more of the computing devices 400 may implement or be implemented by the one or more components of the CE 300. Systems described herein may implement a single computing device, a plurality of computing devices, etc., configured to individually and/or collectively perform functions related to the systems and methods of the present disclosure. In an example, the CTEE 316 and/or the MOCE/computing system 304 may implement or include one or more of the computing devices 400.

The computing device 400 may include control circuitry 404 that may be, for example, one or more processors or processing devices, a central processing unit processor (a, CPU, such as a CPU configured to operate a protected memory space in accordance with a TEE), an integrated circuit or any suitable computing or computational device, an operating system 408, a memory 412, executable code 416, input devices or circuitry 420, and output devices or circuitry 424. The control circuitry 404 (or one or more controllers or processors, possibly across multiple units or devices) may be configured to implement functions of the systems and methods described herein. More than one of the computing devices 400 may be included in, and one or more of the computing devices 400 may act as the components of, a system according to embodiments of the disclosure. Various components of the computing device 400 may be implemented with same or different circuitry, same or different processors or processing devices, etc.

The operating system 408 may be or may include any code segment (e.g., one similar to the executable code 416 described herein) designed and/or configured to perform tasks involving coordination, scheduling, arbitration, supervising, controlling or otherwise managing operation of the control circuitry 404 (e.g., scheduling execution of software programs or tasks or enabling software programs or other hardware modules or units to communicate). The operating system 408 may be a commercial operating system. The operating system 408 may be an optional component (e.g., in some embodiments, a system may include a computing device that does not require or include the operating system 408). For example, a computer system may be, or may include, a microcontroller, an application specific circuit (ASIC), a field programmable array (FPGA), network controller (e.g., CAN bus controller), associated transceiver, system on a chip (SOC), and/or any combination thereof that may be used without an operating system.

The memory 412 may be or may include, for example, Random Access Memory (RAM), read only memory (ROM), Dynamic RAM (DRAM), Synchronous DRAM (SD-RAM), a double data rate (DDR) memory chip, Flash memory, volatile memory, non-volatile memory, cache memory, a buffer, a short-term memory unit, a long-term memory unit, or other suitable memory units or storage units. The memory 412 may be or may include a plurality of memory units, which may correspond to same or different types of memory or memory circuitry. The memory 412 may be a computer or processor non-transitory readable medium, or a computer non-transitory storage medium, e.g., RAM.

The executable code 416 may be any executable code, e.g., an application, a program, a process, task, or script. The executable code 416 may be executed by the control circuitry 404, possibly under control of the operating system 408. Although, for the sake of clarity, a single item of the executable code 416 is shown, a system according to some embodiments of the disclosure may include a plurality of executable code segments similar to the executable code 416 that may be loaded into the memory 412 and cause the control circuitry 404 to carry out methods described herein. Where applicable, the terms “process” and “executable code” may be used interchangeably herein. For example, verification, validation and/or authentication of a process may mean verification, validation and/or authentication of executable code.

In some examples, the memory 412 may include non-volatile memory having the storage capacity of a storage system. In other examples, the computing device 400 may include or communicate with a storage system and/or database. Such a storage system may include, for example, flash memory, memory that is internal to, or embedded in, a micro controller or chip, a hard disk drive, a solid-state drive, a CD-Recordable (CD-R) drive, a Blu-ray disk (BD), a universal serial bus (USB) device or other suitable removable and/or fixed storage unit. Content may be stored in the storage system and loaded from the storage system into the memory 412 where it may be processed by the control circuitry 404.

The input circuitry 420 may be or may include any suitable input devices, components, or systems, e.g., physical sensors such as accelerometers, thermometers, microphones, analog to digital converters, etc., a detachable keyboard or keypad, a mouse, etc. The output circuitry 424 may include one or more (possibly detachable) displays or monitors, motors, servo motors, speakers and/or any other suitable output devices. Any applicable input/output (I/O) devices may be connected to the control circuitry 404. For example, a wired or wireless network interface card (NIC), a universal serial bus (USB) device, or external storage device may be included in the input circuitry 420 and/or the output circuitry 424. It will be recognized that any suitable number of input devices and output devices may be operatively connected to the control circuitry 404. For example, the input circuitry 420 and the output circuitry 424 may be used by a technician or engineer in order to connect to the control circuitry 404, update software, and the like.

Embodiments may include an article such as a computer or processor non-transitory readable medium, or a computer or processor non-transitory storage medium, such as for example memory, a disk drive, or USB flash memory, encoding, including or storing instructions (e.g., computer-executable instructions, which, when executed by a processor or controller, carry out methods disclosed herein), a storage medium such as the memory 412, computer-executable instructions such as the executable code 416, and a controller such as the control circuitry 404.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the disclosure may include components such as, but not limited to, a plurality of central processing units (CPU) or any other suitable multi-purpose or specific processors or controllers (e.g., controllers similar to the control circuitry 404), a plurality of input units, a plurality of output units, a plurality of memory units, and a plurality of storage units, etc. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on-board system or network, a plurality of chips, FPGAs or SOCs, microprocessors, transceivers, microcontrollers, a plurality of computer or network devices, any other suitable computing device, and/or any combination thereof. For example, a system as described herein may include one or more devices such as the control circuitry 404.

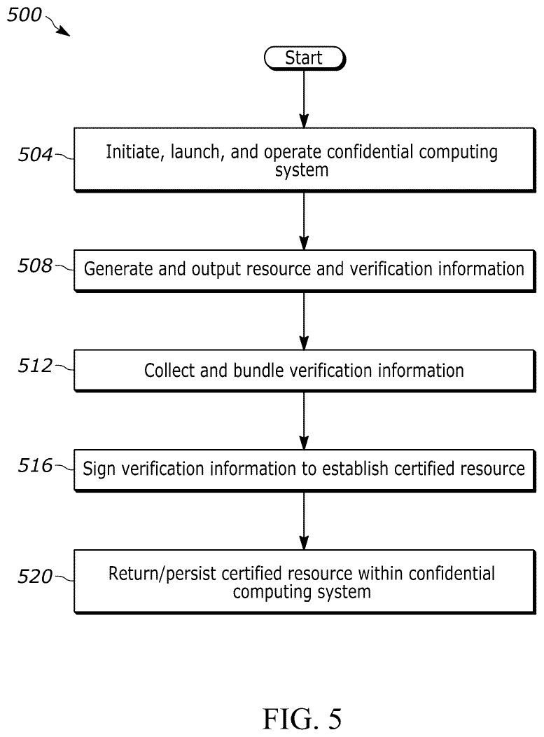

FIG. 5 illustrates steps of an example method 500 for performing resource certification in a confidential, cooperative computing environment according to the principles of the present disclosure. For example, one or more computing devices, processors or processing devices, etc. are configured to execute instructions to implement the method 500, such as one or more of processors of the systems described herein. In an example, the CE 300 (e.g., the MOCE 304, the CTEE 316, etc.) implements all or portions of the method 500.

At 504, the method 500 includes initiating and operating a confidential computing environment/system to facilitate cooperative computing. For example, a CTEE or management gateway is launched on a confidential computing system, an interface (e.g., an API, CMI, etc. as described herein) is executed to provide access for management functionality to PPs (e.g., via a management gateway), a setup process is initiated, assessed, and approved by PPs, and a build process is launched to being operation of a confidential computing system (e.g., a managed cluster/MOCE).

At 508, the method 500 includes generating a resource within the confidential computing system. Generating the resource may include executing steps/stages of a pipeline. Generating the resource includes providing/outputting, along with the resource, verification information about the configuration of the MOCE and other attributes as described herein.

At 512, the method 500 includes (e.g., at a signing service within the confidential computing system) collecting and storing/embedding/bundling, along with the resource, the verification information. At 516, the method 500 includes (e.g., at the signing service) signing the verification information. In other words, the generated resource is established as a certified resource.

At 520, the method 500 includes (e.g., at the signing service) returning, executing, and/or persisting the certified resource, the collected information, and the applied signature within the confidential computing environment. In other words, the certified resource is executed within the MOCE and made available for use by one or more PPs within the confidential computing system.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The various steps and logic performed herein can be executed with non-volatile storage, memory, and processors. Non-volatile storage may include one or more persistent data storage devices such as a hard drive, optical drive, tape drive, non-volatile solid-state device, cloud storage or any other device configured to persistently store information. Processor may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. Memory may include a single memory device or a number of memory devices including, but not limited to, random access memory (RAM), volatile memory, non-volatile memory, static random access memory (SRAM), dynamic random access memory (DRAM), flash memory, cache memory, or any other device configured to store information.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrases “at least one of A, B, and C” and “at least one of A, B, or C” should be construed to mean a logical (A OR B OR C), using a non-exclusive logical OR, and should not be construed to mean “at least one of A, at least one of B, and at least one of C.”

The terms “a,” “an,” “the,” and “said” as used herein in connection with any type of processing component configured to perform various functions may refer to one processing component configured to perform each and every function, or a plurality of processing components collectively configured to perform each of the various functions. By way of example, “A processor” configured to perform actions A, B, and C may refer to one or more processors configured to perform actions A, B, and C. In addition, “a processor” (or, “a processing device,” “a computing device,” and so on) configured to perform actions A, B, and C may also refer to a first processor configured to perform actions A and B, and a second processor configured to perform action C. Further, “A processor” configured to perform actions A, B, and C may also refer to a first processor configured to perform action A, a second processor configured to perform action B, and a third processor configured to perform action C.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

What is claimed is:

1. A method for generating a certified resource for a multi-owned computing environment (MOCE), the method comprising, using one or more computing devices:
establishing a confidential computing system using a trusted execution environment (TEE), the confidential computing system including the MOCE;
generating, within the MOCE, a resource configured to be used by one or more participating parties (PPs) associated with the MOCE;
collecting verification information associated with the resource, wherein the verification information includes information indicating at least a configuration of the MOCE;
using a signing service to establish the resource as the certified resource by applying a digital signature to the verification information and bundling the resource with the verification information; and
storing the certified resource within the MOCE for use by the one or more PPs.

2. The method of claim 1, wherein generating the certified resource includes:
executing, on the confidential computing system, a controller in the TEE (CTEE);
executing, using the CTEE, an interface configured to provide, to the PPs, access to the MOCE;
receiving, via the interface from a requesting PP of the PPs, a request to generate the certified resource; and
in response to a determination that the PPs approved the request, generating the certified resource in accordance with one or more criteria defined by the request.

3. The method of claim 1, wherein the verification information includes information indicating attributes of the resource.

4. The method of claim 1, further comprising, using the signing service, collecting additional information to bundle with the resource, wherein the additional information includes at least one of a list of contributing PPs, a remote attestation report, and system logs.

5. The method of claim 1, wherein applying the digital signature includes at least one of calculating a cryptographic digest for the verification information and signing the verification information with a private key.

6. The method of claim 1, wherein the signing service is implemented within the MOCE, and wherein generating a signing key includes:
verifying integrity of the signing service within the MOCE by a controller in the TEE (CTEE);
generating a pair of cryptographic keys by the signing service using a random number generator;
sending to the CTEE a first public key from the pair of cryptographic keys;
receiving a certificate from the CTEE validating the first public key; and
using a second private key from the pair of cryptographic keys to generate a digital signature over the resource and attaching the first public key and certificate.

7. The method of claim 1, wherein the signing service is implemented within the MOCE, and wherein generating a signing key includes:
verifying integrity of the signing service within the MOCE by a controller in the TEE (CTEE);
receiving a pair of cryptographic keys from the CTEE with a certificate validating a first public key of the pair of cryptographic keys; and
using a second private key of the pair of cryptographic keys to generate a digital signature over the resource and attaching the first public key and certificate.

8. The method of claim 1, wherein the signing service is implemented outside the MOCE using a second confidential computing system, wherein generating a signing key includes:
verifying integrity of the signing service using remote attestation by a controller in a TEE (CTEE);
generating a pair of cryptographic keys by the signing service using a random number generator;
sending to the CTEE a first public key from the pair of keys;
receiving a certificate from the CTEE validating the first public key; and using a second private key from the pair of keys to generate a digital signature over the resource and attaching the first public key and certificate.

9. The method of claim 1, wherein the resource includes native Kubernetes resources, the method further comprising:
collecting additional information including at least one of a resource identifier, a rule configuration of the MOCE, and a general configuration of the MOCE;
generating, using the signing service, a certification of the resource comprising a cryptographic digest over the additional information; and
attaching the certification to the resource.

10. The method of claim 9, wherein certification information is published to a separate channel comprising a log file.

11. The method of claim 9, wherein generating and attaching the certification is triggered automatically upon creation of a new Kubernetes resource.

12. The method of claim 9, wherein generating the certification includes:
using the signing service to store the collected information and a resource digest in a tamper proof file system configured to maintain data in a chronological order.

13. The method of claim 12, wherein the tamper proof file system includes a cryptographic hash chain.

14. The method of claim 1, wherein creating the certification includes:
creating a digital signature on the collected verification information using a signing service; and
embedding the digital signature into the resource using watermarking technologies.

15. A system configured to generate a certified resource for a multi-owned computing environment (MOCE), the system comprising:
one or more computing devices configured to
establish a confidential computing system using a trusted execution environment (TEE), the confidential computing system including the MOCE,
generate, within the MOCE, a resource configured to be used by one or more participating parties (PPs) associated with the MOCE,
collect verification information associated with the resource, wherein the verification information includes information indicating at least a configuration of the MOCE,
use a signing service to establish the resource as the certified resource by applying a digital signature to the verification information and bundling the resource with the verification information, and
store the certified resource within the MOCE for use by the one or more PPs.

16. The system of claim 15, wherein generating the certified resource includes:
executing, on the confidential computing system, a controller in the TEE (CTEE);
executing, using the CTEE, an interface configured to provide, to the PPs, access to the MOCE;
receiving, via the interface from a requesting PP of the PPs, a request to generate the certified resource; and
in response to a determination that the PPs approved the request, generating the certified resource in accordance with one or more criteria defined by the request.

17. The system of claim 15, wherein the verification information includes information indicating attributes of the resource.

18. The system of claim 15, wherein the one or more computing devices are further configured to, using the signing service, collect additional information to bundle with the resource, wherein the additional information includes at least one of a list of contributing PPs, a remote attestation report, and system logs.

19. The system of claim 15, wherein applying the digital signature includes at least one of calculating a cryptographic digest for the verification information and signing the verification information with a private key.

20. The system of claim 15, wherein the signing service is implemented within the MOCE, and wherein generating a signing key includes:
verifying integrity of the signing service within the MOCE by a controller in the TEE (CTEE);
generating a pair of cryptographic keys by the signing service using a random number generator;
sending to the CTEE a first public key from the pair of cryptographic keys;
receiving a certificate from the CTEE validating the first public key; and using a second private key from the pair of cryptographic keys to generate a digital signature over the resource and attaching the first public key and certificate.
